(19) United States
(12) Patent Application Publication
(10) Pub. No.: US 2024/0020154 A1
(43) Pub. Date: Jan. 18, 2024

(54) MANAGEMENT DEVICE, ARITHMETIC PROCESSING DEVICE, AND LOAD DISTRIBUTION METHOD AND COMPUTER-READABLE RECORDING MEDIUM STORING PROGRAM OF ARITHMETIC PROCESSING DEVICE

(71) Applicant: Fujitsu Limited, Kawasaki-shi (JP)

(72) Inventors: Masashi HAYANO, Shinjuku (JP); Takumi HONDA, Kawasaki (JP); Naoto FUKUMOTO, Kawasaki (JP)

(73) Assignee: Fujitsu Limited, Kawasaki-shi (JP)

(21) Appl. No.: 18/308,824

(22) Filed: Apr. 28, 2023

(30) Foreign Application Priority Data
Jul. 12, 2022 (JP) 2022-111887

(51) Int. Cl. G06F 9/48; G06F 7/57

(52) U.S. Cl. CPC G06F 9/4881; G06F 7/57

(57) ABSTRACT

A device includes a processor configured to: classify arithmetic processing devices that executes tasks in parallel by distributing loads into arithmetic processing device groups; select a representative arithmetic processing device; notify the representative arithmetic processing device of identification information of other arithmetic processing devices of an arithmetic processing device group to which the representative arithmetic processing device belongs; instruct the representative arithmetic processing device to acquire information regarding tasks to be executed by the arithmetic processing devices of the arithmetic processing device group from a first task list, and to generate a second task list; notify each other arithmetic processing devices of identification information of the representative arithmetic processing device; and instruct each other arithmetic processing device to acquire information regarding tasks to be executed by the representative arithmetic processing device and each other arithmetic processing device from the second task list, and to generate a third task list.

### CROSS-REFERENCE TO RELATED APPLICATION

This application is based upon and claims the benefit of priority of the prior Japanese Patent Application No. 2022-111887, filed on Jul. 12, 2022, the entire contents of which are incorporated herein by reference.

### FIELD

The embodiments discussed herein are related to a management device, an arithmetic processing device, a load distribution method of the arithmetic processing device, and a load distribution program of the arithmetic processing device.

### BACKGROUND

A technology has been proposed that performs processing on large-scale data at high speed by executing tasks by distributing loads among a plurality of nodes by high-performance computing (HPC). For example, in screening performed in an initial stage of drug discovery research, it is needed to deal with a very large number of compound groups. Therefore, a technology of virtual screening using the HPC has been proposed.

Japanese Laid-open Patent Publication No. 11-053328, Japanese Laid-open Patent Publication No. 05-298272, and “VirtualFlow”, [online], [retrieved on Jun. 29, 2022], Internet <https://docs.virtual-flow.org/documentation/-LdE8RH9UN4HKpckqkX3/> are disclosed as related art.

### SUMMARY

According to an aspect of the embodiments, a management device includes: a memory; and a processor coupled to the memory and configured to: classify a plurality of arithmetic processing devices that executes a plurality of tasks in parallel by distributing loads into a plurality of arithmetic processing device groups; select a representative arithmetic processing device from arithmetic processing devices that belong to each arithmetic processing device group; notify the representative arithmetic processing device of identification information of other arithmetic processing devices that belong to an arithmetic processing device group to which the representative arithmetic processing device belongs; instruct the representative arithmetic processing device to acquire information regarding tasks to be executed by the arithmetic processing devices that belong to the arithmetic processing device group from a first task list as a shared file in which information regarding the plurality of tasks is stored, and to generate a second task list; notify each of the other arithmetic processing devices of identification information of the representative arithmetic processing device; and instruct each of the other arithmetic processing devices to acquire information regarding tasks to be executed by the representative arithmetic processing device and each of the other arithmetic processing devices from the second task list generated by the representative arithmetic processing device, and to generate a third task list.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing virtual screening;

FIG. 2 is a diagram for describing an existing technology of virtual screening using high-performance computing (HPC);

FIG. 3 is a diagram for describing the existing technology of the virtual screening using the HPC;

FIG. 4 is a diagram for describing the existing technology of the virtual screening using the HPC;

FIG. 5 is a diagram for describing the existing technology of the virtual screening using the HPC;

FIG. 6 is a diagram for describing a problem of the existing technology of the virtual screening using the HPC;

FIG. 7 is a block diagram illustrating a schematic configuration of a load distribution system according to first and second embodiments;

FIG. 8 is a functional block diagram of a management device according to the first embodiment;

FIG. 9 is a diagram for describing processing of the management device according to the first embodiment;

FIG. 10 is a functional block diagram of a node according to the first and second embodiments;

FIG. 11 is a diagram for describing access to a task list in the first embodiment;

FIG. 12 is a block diagram illustrating a schematic configuration of a computer that functions as the management device;

FIG. 13 is a block diagram illustrating a schematic configuration of a computer that functions as the node;

FIG. 14 is a flowchart illustrating an example of management processing according to the first embodiment;

FIGS. 15A and 15B are a flowchart illustrating an example of representative node processing according to the first embodiment;

FIG. 16 is a flowchart illustrating an example of member processing according to the first and second embodiments;

FIG. 17 is a diagram for describing an effect of the first embodiment;

FIG. 18 is a functional block diagram of a management device according to the second embodiment;

FIG. 19 is a diagram for describing processing of the management device according to the second embodiment;

FIG. 20 is a diagram for describing access to a task list in the second embodiment;

FIG. 21 is a flowchart illustrating an example of management processing according to the second embodiment;

FIG. 22 is a flowchart illustrating an example of representative node processing according to the second embodiment; and

FIG. 23 is a diagram for describing an effect of the second embodiment.

### DESCRIPTION OF EMBODIMENTS

Furthermore, as a technology related to load distribution among a plurality of nodes, a parallel computer system has been proposed in which a loop is divided and executed in parallel by each node processor. In this system, a host processor obtains a division loop length for an original loop described in a program by performing division by using a maximum integer value less than a loop length of the original loop divisible by the number of node processors as a dividend and the number of node processors as a divisor. Then, the same number of division loops as the number of node processors having this division loop length are generated from the original loop, and an execution process of each of these division loops is assigned to the node processor, and the remaining execution process of the original loop is assigned to the host processor itself.

Furthermore, a parallel processing apparatus has been proposed that executes an iterative sequence of instructions by arranging the sequence into subtasks and allocating those subtasks to processors. The division and the allocation are conducted in such a manner as to minimize data contention among the processors and also to maximize locality of data to the processors.

For example, in the technology of virtual screening using the HPC described above, information regarding a compound (ligand) to be screened is managed in a task list as a single shared file. Therefore, each of a plurality of nodes that executes parallel processing needs to generate a subtask list for tasks to be executed by the own node from the shared file. Since it is needed to avoid contention in accessing the shared file, generation of the subtask list by each node is sequential processing. Therefore, as the number of nodes that execute the parallel processing increases, a standby time for accessing the shared file increases, and the generation of the subtask list by each node becomes an overhead when tasks are executed in the HPC.

Furthermore, the technology related to load distribution among a plurality of nodes described above focuses on a point of effectively dividing loop processing during program execution into processors, and may not resolve a problem that a standby time for accessing a shared file increases.

As one aspect, the disclosed technology aims to reduce a standby time for accessing a task list shared by a plurality of arithmetic processing devices that executes parallel processing of tasks.

Hereinafter, examples of embodiments according to the disclosed technology will be described with reference to the drawings. In each of the following embodiments, an example of applying the disclosed technology to virtual screening will be described.

First, before each embodiment is described, virtual screening, the existing technology of virtual screening using high-performance computing (HPC) described above, and a problem of the existing technology will be described.

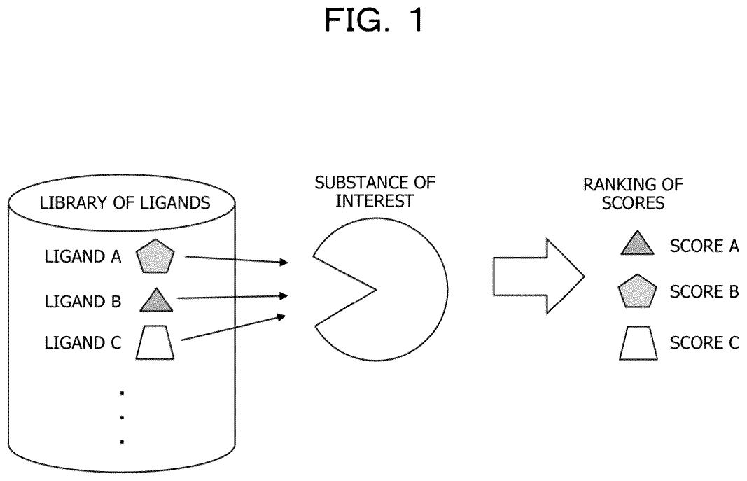

The virtual screening is to search for a ligand that binds to a substance of interest (target protein) from a large number of candidates by calculation using a computer. For example, as illustrated in FIG. 1, the computer calculates, based on information regarding a plurality of ligands stored in a library, a score indicating a degree of binding between each ligand and the substance of interest by, for example, whether or not the ligand has a shape and a property that match the substance of interest, or the like. The computer presents the ligands to a user in ranking order of the scores. Experimental evaluation of whether or not the ligands bind to the substance of interest is expensive and time-consuming per a single ligand. Moreover, there are cases where it is only possible to find a ligand that binds to the substance of interest with a low probability. The virtual screening enables high-speed screening by simulation using the computer.

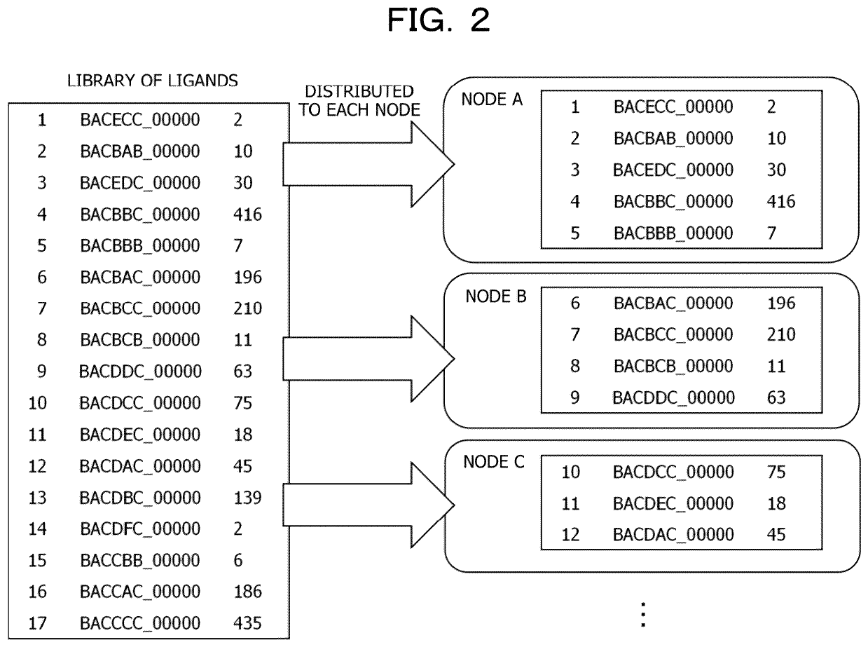

An actual library of ligands is managed in one file as a ligand group in which a plurality of ligands is grouped together. For example, in a library of ligands illustrated in a left diagram of FIG. 2, one line represents a group of a plurality of ligands (ligand group), and “BACECC_00000 2” in the first line represents that one ligand group includes two ligands.

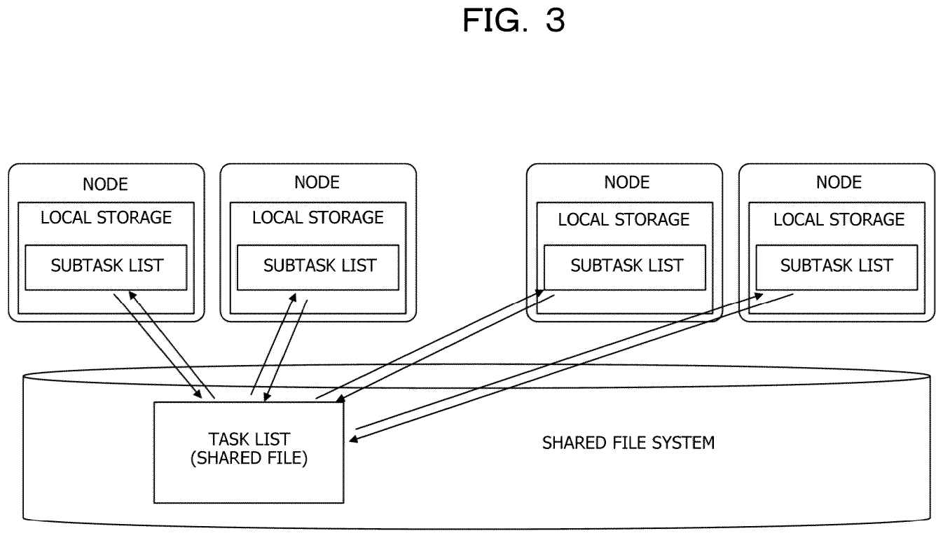

In a case where the HPC is used for the virtual screening, ligand groups are distributed to each node as illustrated in FIG. 2. In the existing technology of the virtual screening using the HPC described above, a task list in which one ligand group (corresponding to one line of the list) of the library of ligands as illustrated in FIG. 2 is one task is managed as a shared file in a shared file system. As illustrated in FIG. 3, each node accesses the task list, generates a subtask list related to tasks to be processed by the own node, stores the generated subtask list in a local storage, and executes each task based on the subtask list. With this configuration, load distribution by the plurality of nodes is implemented.

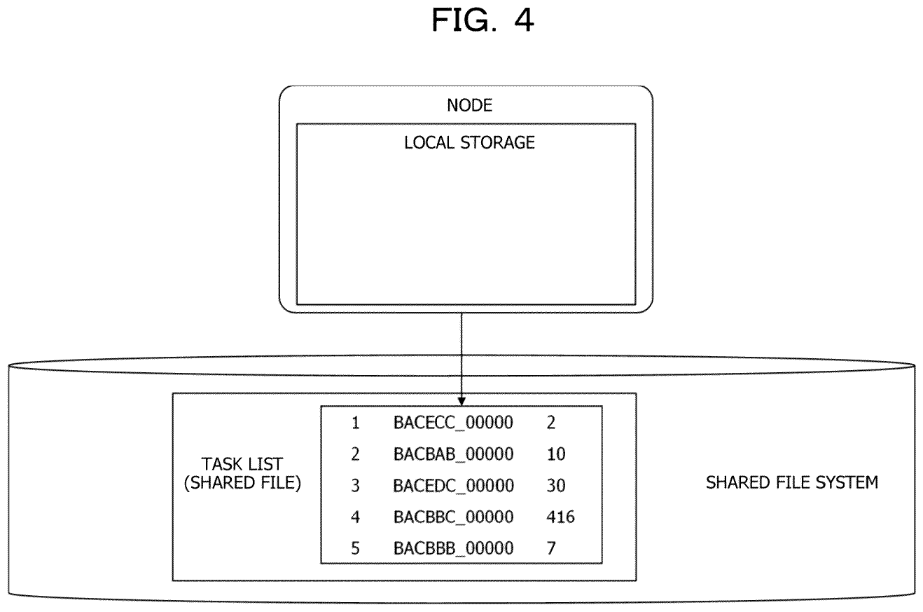

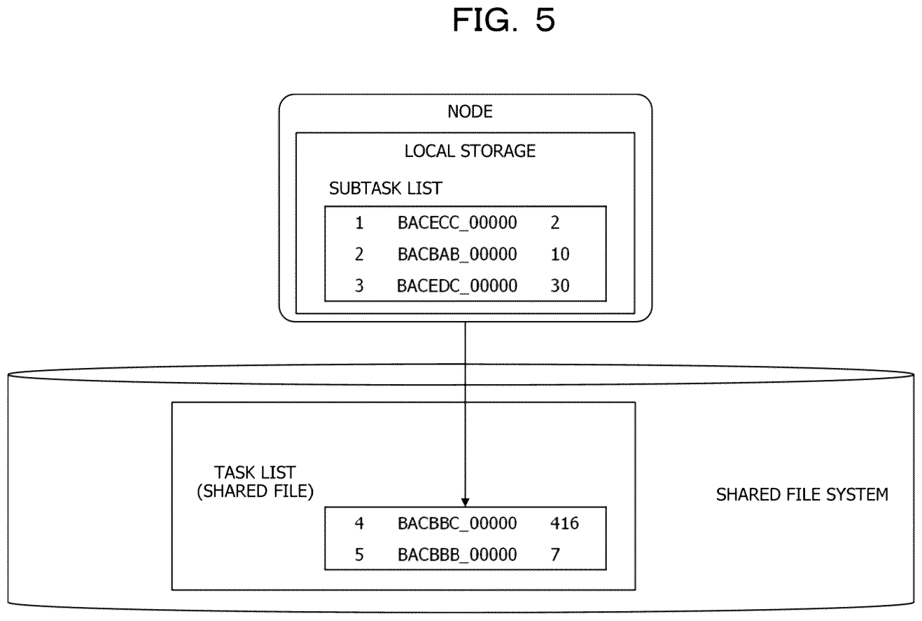

For example, as illustrated in FIG. 4, each node accesses a task list stored in the shared file system. To avoid access contention, only one node is allowed access to the task list. In a case where the node may access the task list, the node locks the task list to set the task list to deny access from another node. Then, the node extracts lines one by one from the task list, and adds the extracted lines to the subtask list of the own node. In a case where a total size of the tasks added to the subtask list exceeds a threshold, or when the tasks are added up to a capacity of the subtask list of the own node, the node ends adding the tasks to the subtask list. For example, in a case where a size of a task is represented by the number of ligands and the threshold of the total size is set to 30, as illustrated in FIG. 5, the total size of the added tasks exceeds the threshold when the tasks up to a third line are added, so the addition of the tasks ends at this stage. Thereafter, the node unlocks the task list.

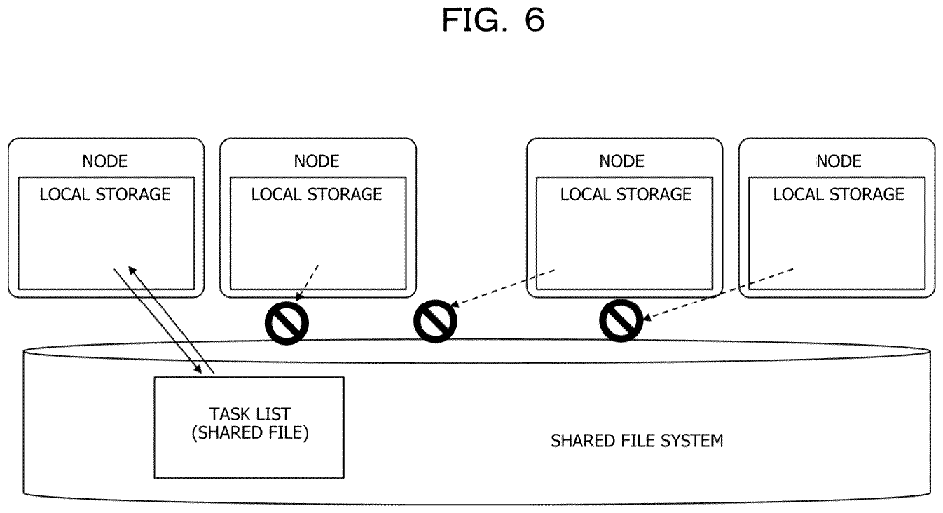

For example, as illustrated in FIG. 6, while a specific node is accessing the task list, the task list is in a locked state and may not be accessed from another node. As a result, an access standby time is generated for another node. For example, in the HPC, the number of nodes is enormous and the number of nodes sometimes reaches tens of thousands, for example, so a frequency of generation of the standby time also increases.

Therefore, in each of the following embodiments, by setting a group of a plurality of nodes as a node group, determining a representative of the node group, and accessing a task list as a shared file by the representative, a standby time for accessing the task list is reduced. Hereinafter, each embodiment will be described.

### First Embodiment

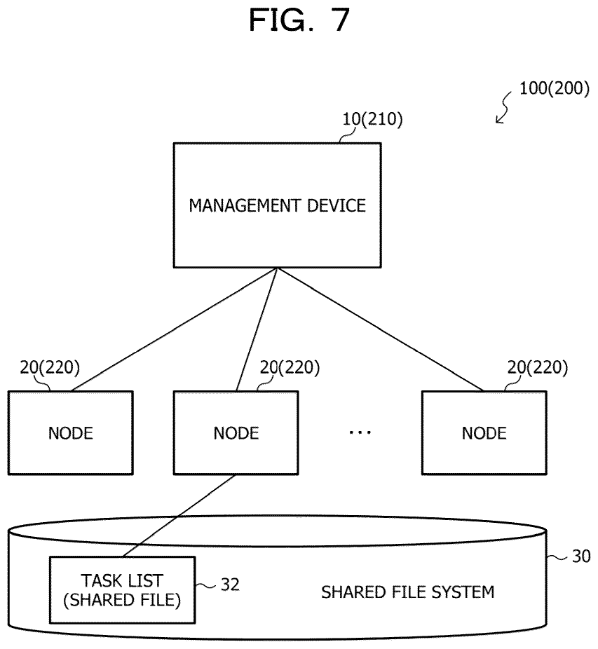

In FIG. 7, a schematic configuration of a load distribution system 100 according to a first embodiment is illustrated. As illustrated in FIG. 7, the load distribution system 100 according to the first embodiment includes a management device 10, a plurality of nodes 20 that executes a plurality of tasks in parallel by distributing loads, and a shared file system 30 that manages a task list 32 as a shared file. Note that the node 20 is an example of an “arithmetic processing device” in the disclosed technology.

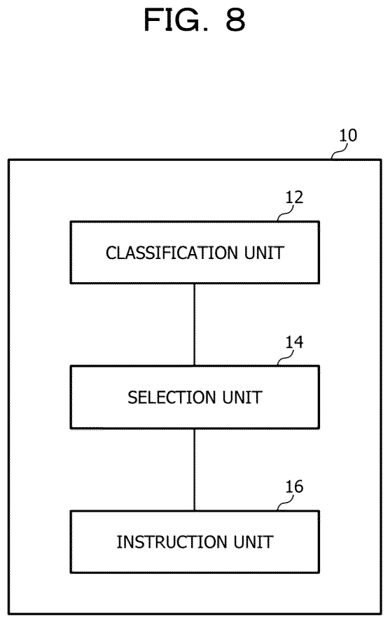

In FIG. 8, a functional block diagram of the management device 10 is illustrated. As illustrated in FIG. 8, the management device 10 functionally includes a classification unit 12, a selection unit 14, and an instruction unit 16.

The classification unit 12 classifies a plurality of nodes into a plurality of node groups. Hereinafter, each node group is also referred to as a “team”, and a node belonging to the team is also referred to as a “member”. For example, the classification unit 12 acquires a list (hereinafter referred to as an “identifier (ID) list”) of identification information (hereinafter referred to as “node ID”) of all nodes reserved for executing a program of the HPC. The classification unit 12 classifies all nodes into a plurality of teams based on the number of members belonging to each team, which is specified in advance by a user.

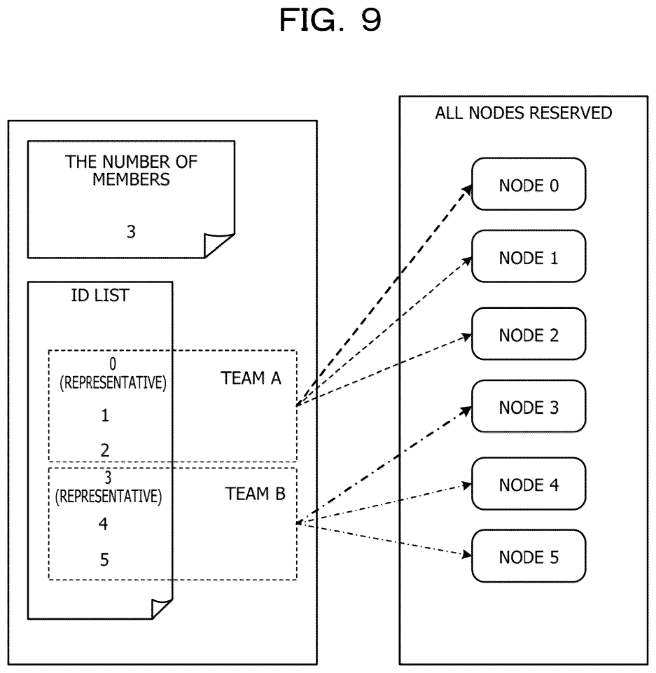

For example, as illustrated in FIG. 9, the classification unit 12 sets lines corresponding to the number of members as one team in order from a first line of the ID list, and assigns identification information (hereinafter referred to as “team ID”) to each team. In the example of FIG. 9, the specified number of members is 3, and the ID list includes node IDs={0, 1, 2, 3, 4, 5}. Therefore, the classification unit 12 sets the nodes 20 with the node IDs={0, 1, 2} as one team, and assigns the team ID=A, for example. Furthermore, the classification unit 12 sets the nodes 20 with the node IDs={3, 4, 5} as one team, and assigns the team ID=B, for example. Hereinafter, a node with the node ID=i is also referred to as “node i”, and a team with the team ID=j is also referred to as “team j”.

The selection unit 14 selects a representative node from nodes belonging to each team. For example, in a case where the node ID is a number, the selection unit 14 selects a node with the smallest node ID among the nodes 20 belonging to each team as the representative node. Note that the method of selecting the representative node is not limited to this, and a node with the largest node ID among the nodes 20 belonging to each team may be selected as the representative node, or the representative node may be randomly selected. FIG. 9 illustrates an example in which the node with the smallest node ID is selected as the representative node, and the representative node of the team A is the node 0, and the representative node of the team B is the node 3.

The instruction unit 16 notifies a representative node that it is a representative of a team and of node IDs of other members belonging to the team to which the representative node belongs. Furthermore, the instruction unit 16 instructs the representative node to acquire information regarding tasks to be executed by the members belonging to the team from the task list 32 as a shared file that stores information regarding a plurality of tasks, and generate a team task list. Furthermore, the instruction unit 16 notifies each of the other members other than the representative node of a node ID of the representative node of the team to which the member belongs. Furthermore, the instruction unit 16 instructs each member to acquire the information regarding the tasks to be executed by the respective members from the team task list generated by the representative node, and generate a subtask list.

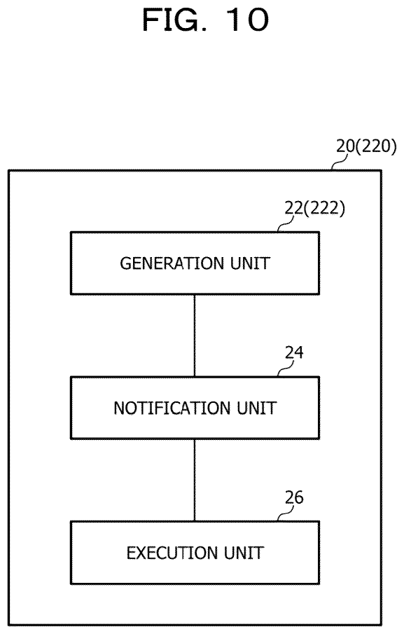

In FIG. 10, a functional block diagram of the node 20 is illustrated. As illustrated in FIG. 10, the node 20 functionally includes a generation unit 22, a notification unit 24, and an execution unit 26.

The generation unit 22 generates a team task list from the task list 32 in a case where it is notified from the management device 10 that the node 20 is a representative of a team and is notified of node IDs of other members belonging to the team. For example, in a case where the task list 32 is accessible, the generation unit 22 locks the task list 32 and then accesses the task list 32. Then, the generation unit 22 extracts information regarding tasks one by one (line by line) from the task list 32, and adds the information to the team task list. The generation unit 22 generates the team task list by ending the acquisition of the information regarding the tasks at a stage when a total size of the acquired information regarding the tasks exceeds a threshold according to the number of members of the team. The generation unit 22 unlocks the task list 32 when the generation of the team task list is completed.

Furthermore, in a case where the node 20 functions as the representative node, the generation unit 22 acquires information regarding tasks to be executed by the own node from the generated team task list, and generates a member task list. Furthermore, in a case where the node 20 functions as a member other than the representative node, the generation unit 22 acquires information regarding tasks to be executed by the own node from the team task list, and generates a member task list. The member other than the representative node generates the member task list of the own node in a case where the member is notified by the notification unit 24 (details will be described later) of the representative node that the team task list has been generated. The team task list is a shared file shared by members belonging to the same team. Therefore, similarly to a case where the representative node accesses the task list 32, the generation unit 22 of each member locks the team task list and then accesses the team task list, and when the generation of the member task list is completed, unlocks the team task list.

The notification unit 24 notifies other members belonging to a team that a team task list has been generated when the generation unit 22 completes generation of the team task list in a case where the node 20 functions as a representative node. Note that it is assumed that notification destinations such as internet protocol (IP) addresses may be specified from node IDs of the members.

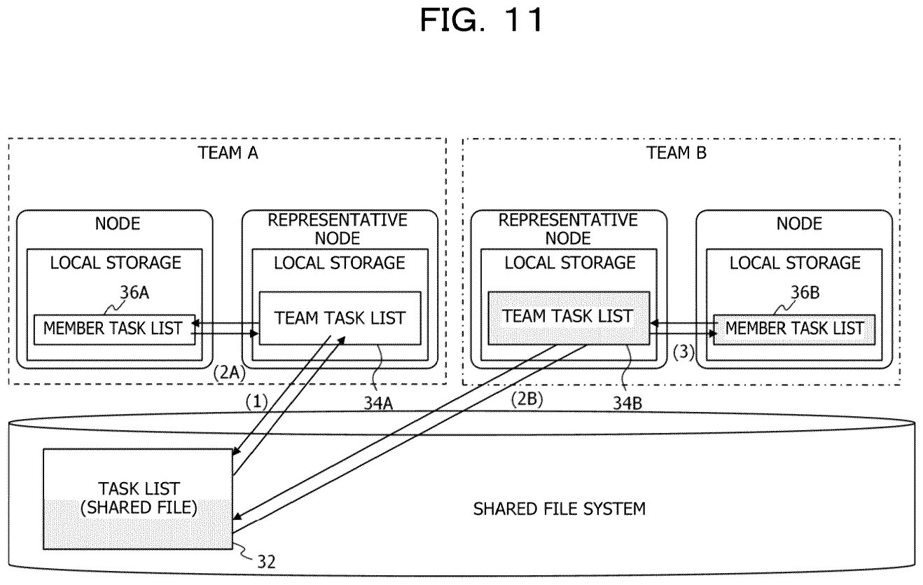

With reference to FIG. 11, access to the task list 32 related to two teams (team A and team B) will be described. First, a representative node of the team A accesses the task list 32, and generates a team task list 34A of the team A ((1) in FIG. 11). During this time, the team B is in a standby state for access to the task list 32. When the generation of the team task list 34A of the team A is completed, a representative node of the team B accesses the task list 32, and generates a team task list 34B of the team B ((2B) in FIG. 11). At the same time, in the team A, each member accesses the team task list 34A, and generates a member task list 36A of each member ((2A) in FIG. 11). Then, when the generation of the team task list 34B of the team B is completed, in the team B, each member accesses the team task list 34B, and generates a member task list 36B of each member ((3) in FIG. 11).

Hereinafter, the team task lists 34A and 34B will be referred to as “team task list 34” in a case where they are described without distinction, and the member task lists 36A and 36B will be referred to as “member task list 36” in a case where they are described without distinction. Note that the task list 32 is an example of a “first task list” of the disclosed technology, the team task list 34 is an example of a “second task list” of the disclosed technology, and the member task list 36 is an example of a “third task list” of the disclosed technology.

When the generation of the member task list 36 by the generation unit 22 is completed, the execution unit 26 executes screening of tasks included in the member task list 36, for example, ligands. For example, the execution unit 26 extracts information regarding the tasks line by line from the member task list 36, accesses information regarding ligand groups indicated by the information regarding the tasks, and calculates a score indicating a degree of binding between each ligand included in each ligand group and a substance of interest.

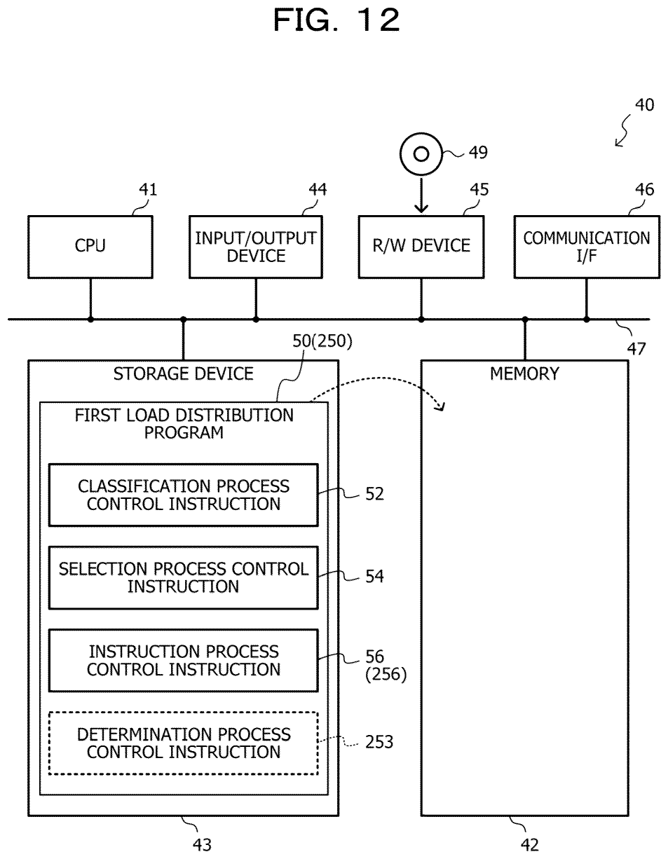

The management device 10 may be implemented by, for example, a computer 40 illustrated in FIG. 12. The computer 40 includes a central processing unit (CPU) 41, a memory 42 as a temporary storage area, and a nonvolatile storage device 43. Furthermore, the computer 40 includes an input/output device 44 such as an input device or a display device, and a read/write (R/W) device 45 that controls reading and writing of data from/to a storage medium 49. Furthermore, the computer 40 includes a communication interface (I/F) 46 to be coupled to a network such as the Internet. The CPU 41, the memory 42, the storage device 43, the input/output device 44, the R/W device 45, and the communication I/F 46 are coupled to one another via a bus 47.

The storage device 43 is, for example, a hard disk drive (HDD), a solid state drive (SSD), a flash memory, or the like. The storage device 43 as a storage medium stores a first load distribution program 50 for causing the computer 40 to function as the management device 10. The first load distribution program 50 includes a classification process control instruction 52, a selection process control instruction 54, and an instruction process control instruction 56.

The CPU 41 reads the first load distribution program 50 from the storage device 43, expands the first load distribution program 50 in the memory 42, and sequentially executes the control instructions included in the first load distribution program 50. The CPU 41 executes the classification process control instruction 52 so as to operate as the classification unit 12 illustrated in FIG. 8. Furthermore, the CPU 41 executes the selection process control instruction 54 so as to operate as the selection unit 14 illustrated in FIG. 8. Furthermore, the CPU 41 executes the instruction process control instruction 56 so as to operate as the instruction unit 16 illustrated in FIG. 8. With this configuration, the computer 40 that has executed the first load distribution program 50 functions as the management device 10. Note that the CPU 41 that executes the program is hardware.

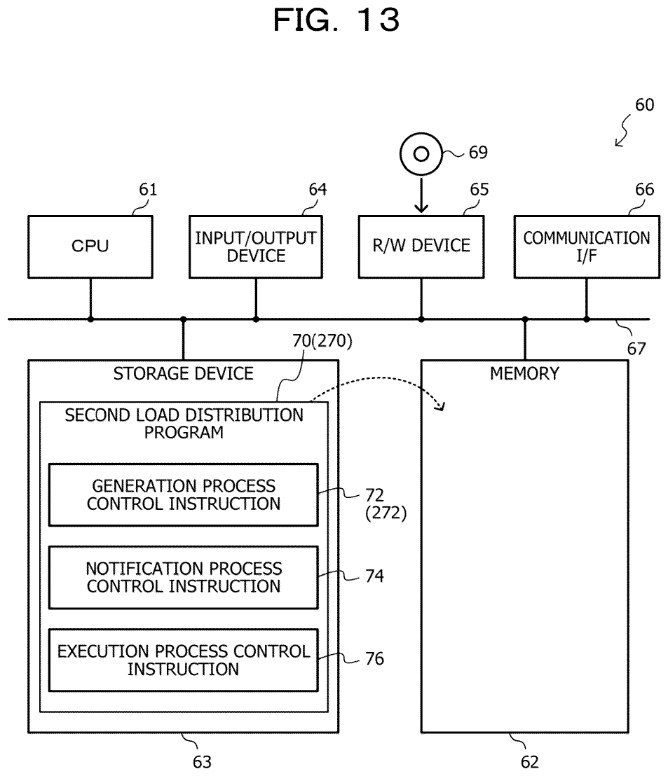

The node 20 may be implemented by, for example, a computer 60 illustrated in FIG. 13. The computer 60 includes a CPU 61, a memory 62, a storage device 63, an input/output device 64, an R/W device 65 that controls reading and writing of data from/to a storage medium 69, and a communication I/F 66. The CPU 61, the memory 62, the storage device 63, the input/output device 64, the R/W device 65, and the communication I/F 66 are coupled to one another via a bus 67.

The storage device 63 stores a second load distribution program 70 for causing the computer 60 to function as the node 20. The second load distribution program 70 includes a generation process control instruction 72, a notification process control instruction 74, and an execution process control instruction 76.

The CPU 61 reads the second load distribution program 70 from the storage device 63, expands the second load distribution program 70 in the memory 62, and sequentially executes the control instructions included in the second load distribution program 70. The CPU 61 executes the generation process control instruction 72 so as to operate as the generation unit 22 illustrated in FIG. 10. Furthermore, the CPU 61 executes the notification process control instruction 74 so as to operate as the notification unit 24 illustrated in FIG. 10. Furthermore, the CPU 61 executes the execution process control instruction 76 so as to operate as the execution unit 26 illustrated in FIG. 10. With this configuration, the computer 60 that has executed the second load distribution program 70 functions as the node 20. Note that the CPU 61 that executes the program is hardware.

Note that the first load distribution program 50 and the second load distribution program 70 are examples of a “load distribution program of the arithmetic processing device” of the disclosed technology. Furthermore, the functions implemented by each of the first load distribution program 50 and the second load distribution program 70 may be implemented by, for example, a semiconductor integrated circuit, for example, an application specific integrated circuit (ASIC), a field-programmable gate array (FPGA), or the like.

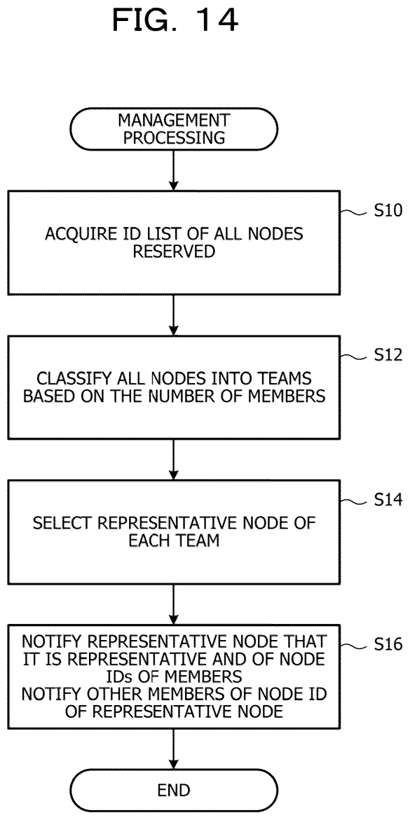

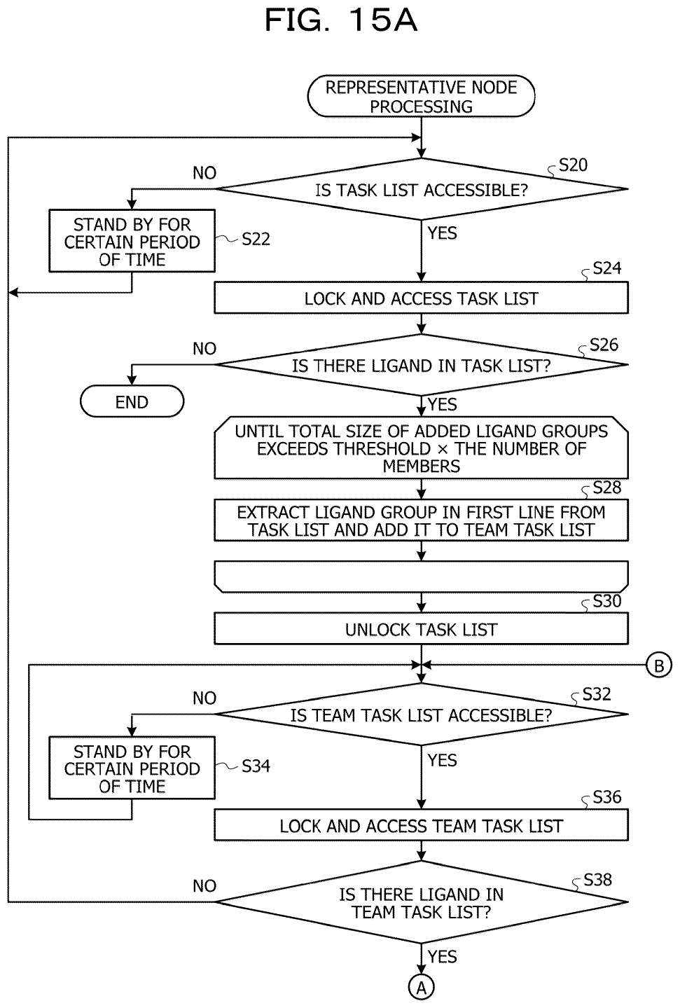

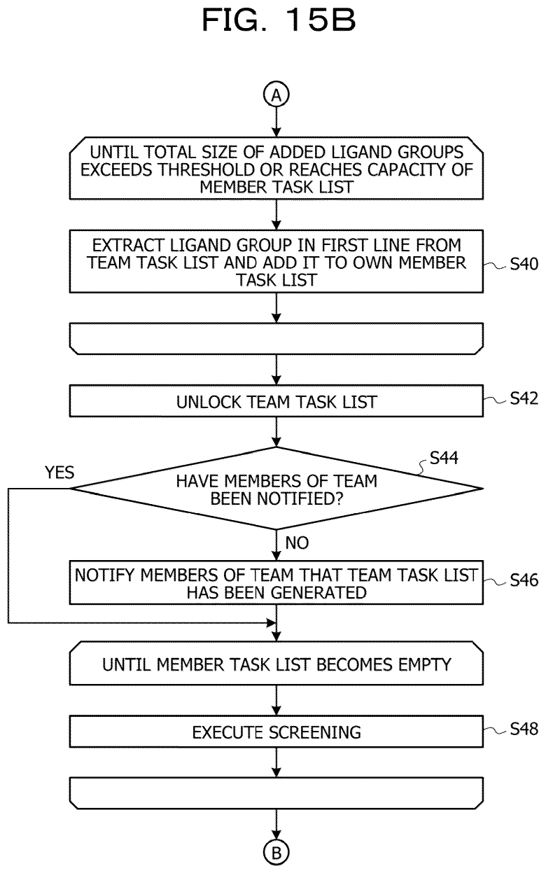

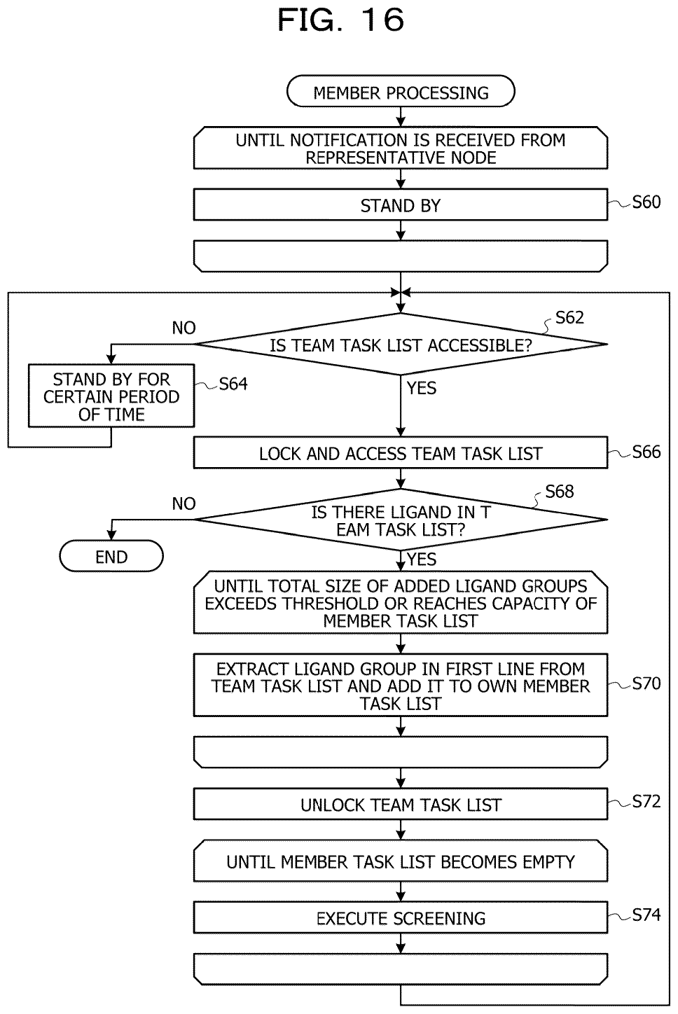

Next, operation of the load distribution system 100 according to the first embodiment will be described. First, the management device 10 executes management processing illustrated in FIG. 14. Then, the node 20 functioning as a representative node executes representative node processing illustrated in FIGS. 15A and 15B, and the node 20 functioning as another member other than the representative node executes member processing illustrated in FIG. 16. Note that the management processing, the representative node processing, and the member processing are examples of a “load distribution method of the arithmetic processing device” of the disclosed technology. Hereinafter, each of the management processing, the representative node processing, and the member processing will be described.

First, the management processing illustrated in FIG. 14 will be described.

In Step S10, the classification unit 12 acquires an ID list of all nodes reserved for executing a program of the HPC. Next, in Step S12, the classification unit 12 classifies all nodes into a plurality of teams based on the number of members specified in advance by a user. Next, in Step S14, the selection unit 14 selects a node with the smallest node ID among the nodes 20 belonging to each team as a representative node.

Next, in Step S16, the instruction unit 16 notifies the representative node that it is a representative of a team and of node IDs of other members belonging to the team to which the representative node belongs, and instructs the representative node to generate the team task list 34 and the member task list 36 of the own node. Furthermore, the instruction unit 16 notifies each of the other members other than the representative node of a node ID of the representative node of the team to which the member belongs, and instructs the member to wait for notification from the representative node and generate the member task list 36, and the management processing ends.

Next, the representative node processing illustrated in FIGS. 15A and 15B will be described. The representative node processing is executed in the node 20 notified from the management device 10 that it is the representative.

In Step S20, the generation unit 22 determines whether or not the task list 32 of the shared file system 30 is accessible. In a case where the task list 32 is locked and is not accessible, the processing proceeds to Step S22, stands by for a certain period of time, and returns to Step S20. In a case where the task list 32 is accessible, the processing proceeds to Step S24.

In Step S24, the generation unit 22 locks the task list 32 and then accesses the task list 32. Next, in Step S26, the generation unit 22 determines whether or not there is a ligand in the task list 32, for example, whether or not there is a remaining line in the task list 32. In a case where there is a ligand in the task list 32, the processing proceeds to Step S28, and in a case where there is no ligand, the representative node processing ends.

In Step S28, the generation unit 22 executes processing of extracting a ligand group (information regarding tasks) in a first line from the task list 32 and adding the extracted ligand group to the team task list 34, until a total size of the added ligand groups exceeds a threshold×the number of members. Next, in Step S30, the generation unit 22 unlocks the task list 32.

Next, in Step S32, the generation unit 22 determines whether or not the team task list 34 is accessible. In a case where it is not accessible, the processing proceeds to Step S34, stands by for a certain period of time, and returns to Step S32. In a case where it is accessible, the processing proceeds to Step S36.

In Step S36, the generation unit 22 locks the team task list 34 and then accesses the team task list 34. Next, in Step S38, the generation unit 22 determines whether or not there is a ligand in the team task list 34. In a case where there is a ligand in the team task list 34, the processing proceeds to Step S40, and in a case where there is no ligand, the processing returns to Step S20.

In Step S40, the generation unit 22 executes processing of extracting a ligand group in a first line from the team task list 34 and adding the extracted ligand group to the member task list 36 of the own node, until a total size of the added ligand groups exceeds a threshold. Alternatively, the generation unit 22 executes the processing until the total size of the added ligand groups reaches a capacity of the member task list 36 of the own node. Next, in Step S42, the generation unit 22 unlocks the team task list 34.

Next, in Step S44, it is determined whether or not the notification unit 24 has notified the other members belonging to the team that the generation of the team task list 34 has been completed. In a case where the completion has not been notified, the processing proceeds to Step S46, and in a case where the completion has already been notified, the processing proceeds to Step S48. In Step S46, the notification unit 24 notifies the other members belonging to the team that the team task list 34 has been generated. In Step S48, the execution unit 26 executes screening based on the member task list 36 of the own node, and returns to Step S32 in a case where the member task list 36 becomes empty.

Next, the member processing illustrated in FIG. 16 will be described. The member processing is executed in the node 20 notified from the management device 10 of the node ID of the representative node, for example, another node 20 other than the representative node.

In Step S60, the generation unit 22 stands by until the notification of the completion of the generation of the team task list 34 is received from the representative node. When the notification is received, in Steps S62 to S72, the generation unit 22 generates the member task list 36 of the own node similarly to the processing in Steps S32 to S42 of the representative node processing (FIGS. 15A and 15B). Next, in Step S74, the execution unit 26 executes screening based on the member task list 36 of the own node, and returns to Step S62 in a case where the member task list 36 becomes empty.

It is sufficient that results of the screening executed in the respective nodes 20 are aggregated by the management device 10 so that candidates for ligands that bind to the substance of interest are presented according to ranking of scores.

As described above, according to the load distribution system according to the first embodiment, the management device classifies a plurality of nodes into a plurality of teams, and selects a representative node from nodes belonging to each team. Then, the management device notifies the representative node that it is a representative and of node IDs of other members, and notifies the other members of a node ID of the representative node. Then, the representative node generates a team task list to be shared by the team from a task list as a shared file, each node generates a member task list of the own node from the team task list, and each node executes tasks based on the member task list of the own node. With this configuration, it is possible to reduce a standby time for accessing a task list shared by a plurality of arithmetic processing devices that executes parallel processing of tasks, and to shorten a task list generation time in all nodes.

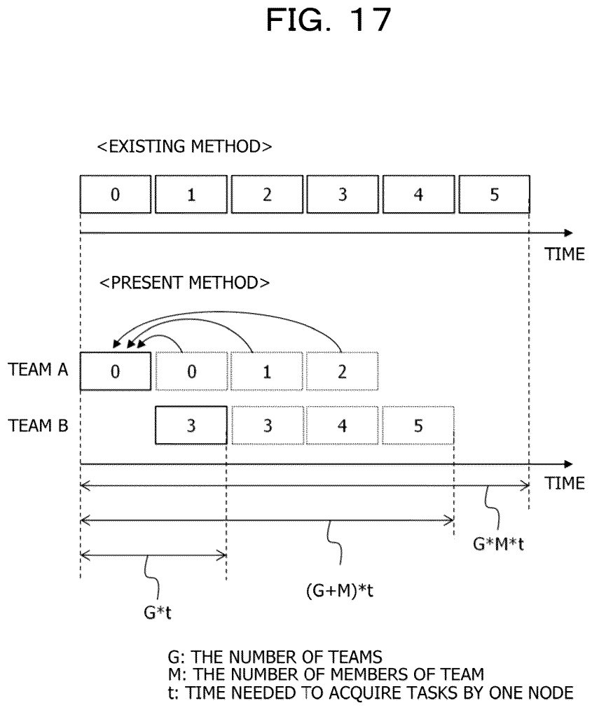

With reference to FIG. 17, an effect of the first embodiment will be specifically described. In FIG. 17, numbers 0 to 5 are node IDs. Furthermore, a box indicated by a solid line is a time needed for each node to acquire tasks from the task list 32, and a box indicated by a dotted line is a time needed for each node to acquire tasks from the team task list 34.

In an existing method, since sequential processing is performed in which all nodes sequentially access the task list 32 as a shared file, a time needed to acquire tasks increases in proportion to the number of nodes. On the other hand, in the method of the present embodiment (hereinafter referred to as “present method”), only a representative node of a team acquires tasks from the task list 32 of the shared file system. Then, each member acquires tasks from the team task list 34 generated by the representative node of the team (arrows in FIG. 17). Therefore, since the file may be accessed like a pipeline, it is possible to reduce a standby time for accessing the task list in the entire system.

Furthermore, when it is assumed that the number of teams is G, the number of members of the team is M, and a time needed to acquire tasks by one node 20 is t, in the existing method, a time T until all nodes complete generation of the member task list 36 is T=G*M*t. On the other hand, in the present method, a time until the generation of the team task list 34 is completed, for example, a time T′ for the representative node to access the task list 32 is T′=G*t. Furthermore, the time T until all nodes complete the generation of the member task list 36 is T=(G+M)*t, which may be greatly shortened compared to the existing method.

### Second Embodiment

Next, a second embodiment will be described. Note that, in a load distribution system according to the second embodiment, similar components to those of the load distribution system 100 according to the first embodiment are denoted by the same reference signs, and detailed description thereof will be omitted.

As illustrated in FIG. 7, a load distribution system 200 according to the second embodiment includes a management device 210, a plurality of nodes 220, and a shared file system 30 that manages a task list 32 as a shared file. Note that the nodes 220 is an example of the “arithmetic processing device” in the disclosed technology.

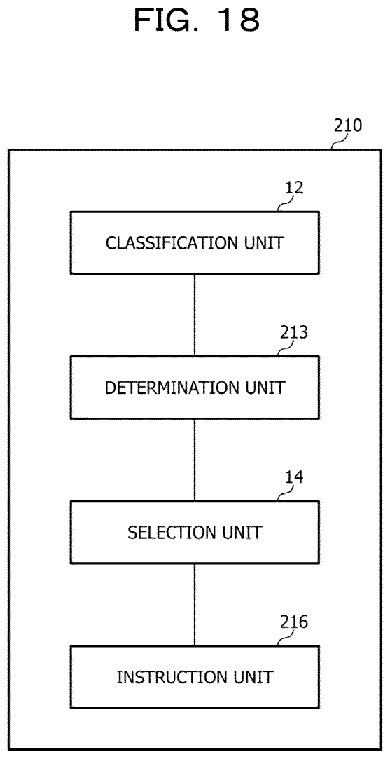

In FIG. 18, a functional block diagram of the management device 210 is illustrated. As illustrated in FIG. 18, the management device 210 functionally includes a classification unit 12, a determination unit 213, a selection unit 14, and an instruction unit 216.

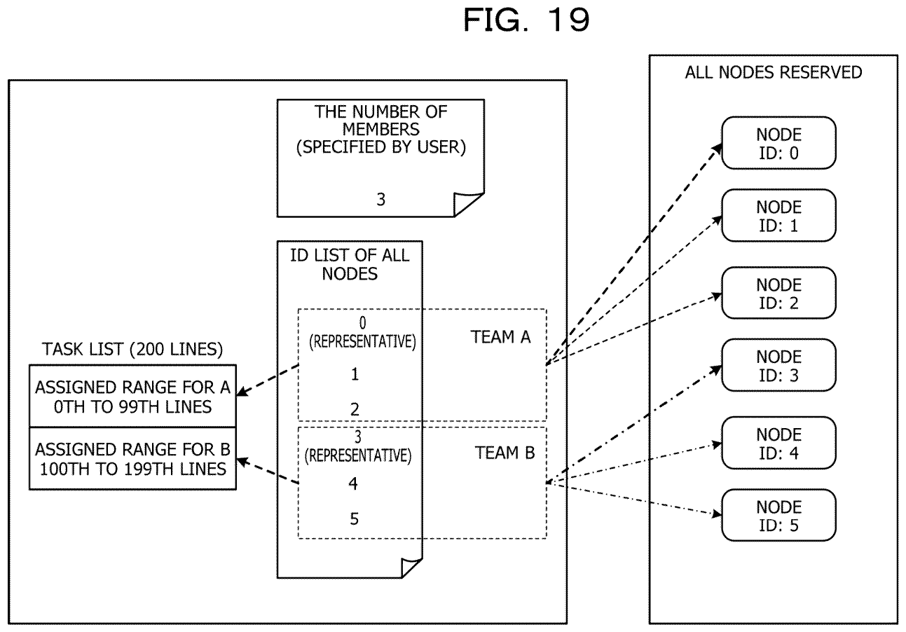

The determination unit 213 divides tasks included in the task list 32 by the number of teams, and determines a range of tasks in the task list 32 assigned to each team. For example, as illustrated in FIG. 19, it is assumed that the nodes 220 are classified into two teams, a team A and a team B, and the task list 32 has 200 lines from 0th to 199th lines. In this case, the determination unit 213 determines that the 0th to 99th lines are an assigned range for the team A, and the 100th to 199th lines are an assigned range for the team B.

The instruction unit 216 notifies, in addition to the notification and the instruction to each node 220 by the instruction unit 16 of the first embodiment, a representative node of each team of an assigned range for the team determined by the determination unit 213. Then, the instruction unit 216 instructs each representative node to generate a team task list 34 from the assigned range for the team in the task list 32.

In FIG. 10, a functional block diagram of the node 220 is illustrated. As illustrated in FIG. 10, the node 220 functionally includes a generation unit 222, a notification unit 24, and an execution unit 26.

The generation unit 222 generates, in a case where an assigned range is notified from the management device 210, for example, in a case where the node 220 functions as a representative node, the team task list 34 from the notified assigned range in the task list 32. For example, by accessing the assigned range for the own team in the task list 32, extracting information regarding tasks in the assigned range from the task list 32, and adding the extracted information to the team task list 34, the generation unit 222 generates the team task list 34. At this time, the task list 32 does not need to be locked because the assigned ranges for the respective teams are divided in advance and there is no access contention. Therefore, each representative node may access the task list 32 at the same time.

Furthermore, the generation unit 222 generates a member task list 36 similarly to the generation unit 22 of the first embodiment.

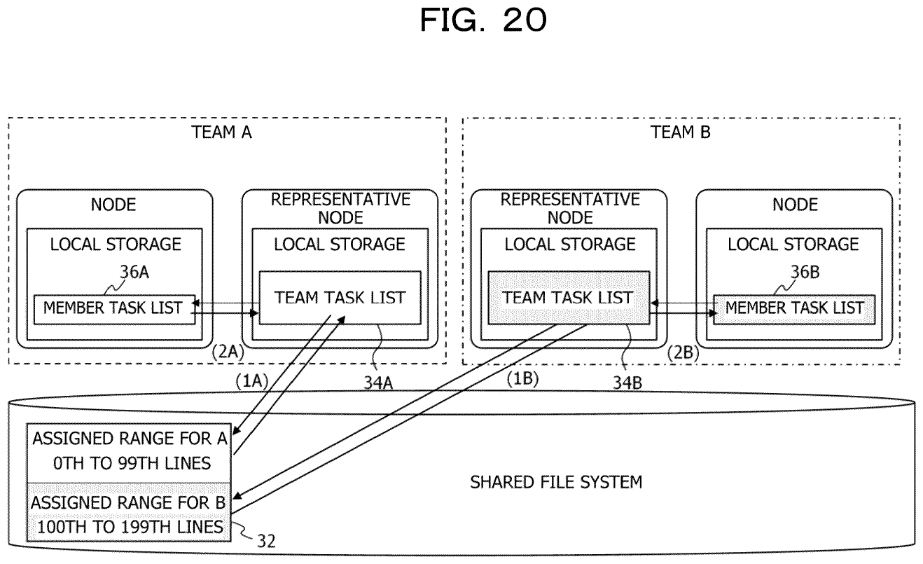

With reference to FIG. 20, access to the task list 32 related to the two teams (team A and team B) will be described. First, a representative node of the team A accesses the assigned range for the team A in the task list 32, and generates a team task list 34A of the team A ((1A) in FIG. 20). At the same time, a representative node of the team B accesses the assigned range for the team B in the task list 32, and generates a team task list 34B of the team B ((1B) in FIG. 20). When the generation of the team task list 34A of the team A is completed, in the team A, each member accesses the team task list 34A, and generates a member task list 36A of each member ((2A) in FIG. 20). Similarly, when the generation of the team task list 34B of the team B is completed, in the team B, each member accesses the team task list 34B, and generates a member task list 36B of each member ((2B) in FIG. 11).

The management device 210 may be implemented by, for example, a computer 40 illustrated in FIG. 12. A storage device 43 of the computer 40 stores a first load distribution program 250 for causing the computer 40 to function as the management device 210. The first load distribution program 250 includes a classification process control instruction 52, a determination process control instruction 253, a selection process control instruction 54, and an instruction process control instruction 256.

A CPU 41 reads the first load distribution program 250 from the storage device 43, expands the first load distribution program 250 in a memory 42, and sequentially executes the control instructions included in the first load distribution program 250. The CPU 41 executes the determination process control instruction 253 so as to operate as the determination unit 213 illustrated in FIG. 18. Furthermore, the CPU 41 executes the instruction process control instruction 256 so as to operate as the instruction unit 216 illustrated in FIG. 18. Other control instructions are similar to those of the first load distribution program 50 according to the first embodiment. With this configuration, the computer 40 that has executed the first load distribution program 250 functions as the management device 210.

The node 220 may be implemented by, for example, a computer 60 illustrated in FIG. 13. A storage device 63 of the computer 60 stores a second load distribution program 270 for causing the computer 60 to function as the node 220. The second load distribution program 270 includes a generation process control instruction 272, a notification process control instruction 74, and an execution process control instruction 76.

A CPU 61 reads the second load distribution program 270 from the storage device 63, expands the second load distribution program 270 in a memory 62, and sequentially executes the control instructions included in the second load distribution program 270. The CPU 61 executes the generation process control instruction 272 so as to operate as the generation unit 222 illustrated in FIG. 10. Other control instructions are similar to those of the second load distribution program 70 according to the first embodiment. With this configuration, the computer 60 that has executed the second load distribution program 270 functions as the node 220.

Note that the first load distribution program 250 and the second load distribution program 270 are examples of the “load distribution program of the arithmetic processing device” of the disclosed technology. Furthermore, the functions implemented by each of the first load distribution program 250 and the second load distribution program 270 may be implemented by, for example, a semiconductor integrated circuit, for example, an ASIC, an FPGA, or the like.

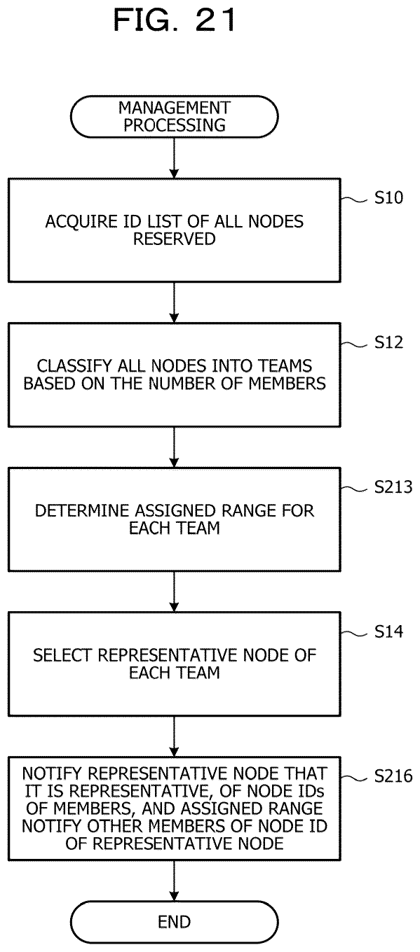

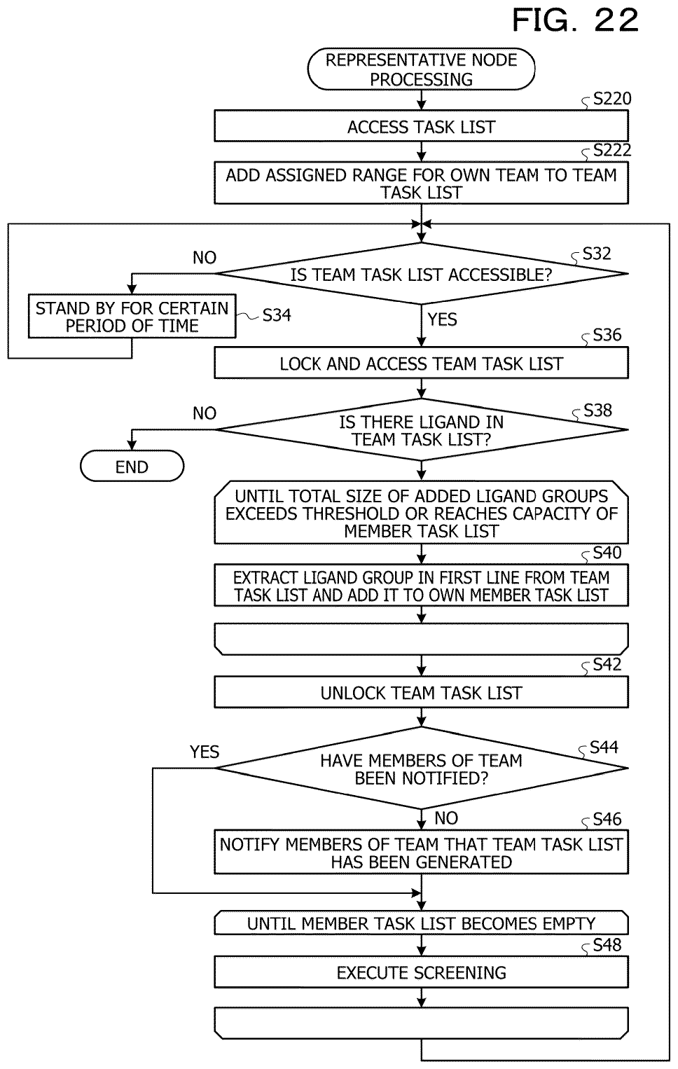

Next, operation of the load distribution system 200 according to the second embodiment will be described. First, the management device 210 executes management processing illustrated in FIG. 21. Then, the node 220 functioning as a representative node executes representative node processing illustrated in FIG. 22, and the node 20 functioning as another member other than the representative node executes member processing similar to that in the first embodiment illustrated in FIG. 16. Note that the management processing, the representative node processing, and the member processing are examples of the “load distribution method of the arithmetic processing device” of the disclosed technology. Hereinafter, each of the management processing and the representative node processing will be described. Note that, for each of the management processing and the representative node processing according to the second embodiment, similar processing to that of the management processing (FIG. 14) and the representative node processing (FIGS. 15A and 15B) according to the first embodiment is denoted by the same step number, and detailed description thereof will be omitted.

First, the management processing illustrated in FIG. 21 will be described.

After Steps S10 and S12, in the next Step S213, the determination unit 213 divides tasks included in the task list 32 by the number of teams, and determines a range of tasks in the task list 32 assigned to each team. After Step S14, in the next Step S216, the instruction unit 216 notifies a representative node that it is a representative of a team and of node IDs of other members belonging to the team to which the representative node belongs, and an assigned range for the team. Then, the determination unit 213 instructs the representative node to generate the team task list 34 and the member task list 36 of the own node. Furthermore, the instruction unit 216 notifies each of the other members other than the representative node of a node ID of the representative node of the team to which the member belongs, and instructs the member to wait for notification from the representative node and generate the member task list 36, and the management processing ends.

Note that the processing of Step S213 and the processing of Step S14 may be executed in a reversed order.

Next, the representative node processing illustrated in FIG. 22 will be described. The representative node processing is executed in the node 220 notified from the management device 210 that it is the representative.

In Step S220, the generation unit 222 accesses the task list 32. Next, in Step S222, by extracting information regarding tasks in the assigned range for the own team notified from the management device 210 from the task list 32, and adding the extracted information to the team task list 34, the generation unit 222 generates the team task list 34. Hereinafter, processing of Steps S32 and S48 is executed similarly to that in the first embodiment, and the representative node processing ends.

As described above, according to the load distribution system according to the second embodiment, the management device divides tasks included in a task list as a shared file by the number of teams, determines a range of tasks in the task list assigned to each team, and notifies a representative node of the assigned range. Then, the representative node generates a team task list from the range of the own team in the task list. With this configuration, it is possible to reduce a standby time for accessing a task list shared by a plurality of arithmetic processing devices that executes parallel processing of tasks, and to shorten a task list generation time in all nodes.

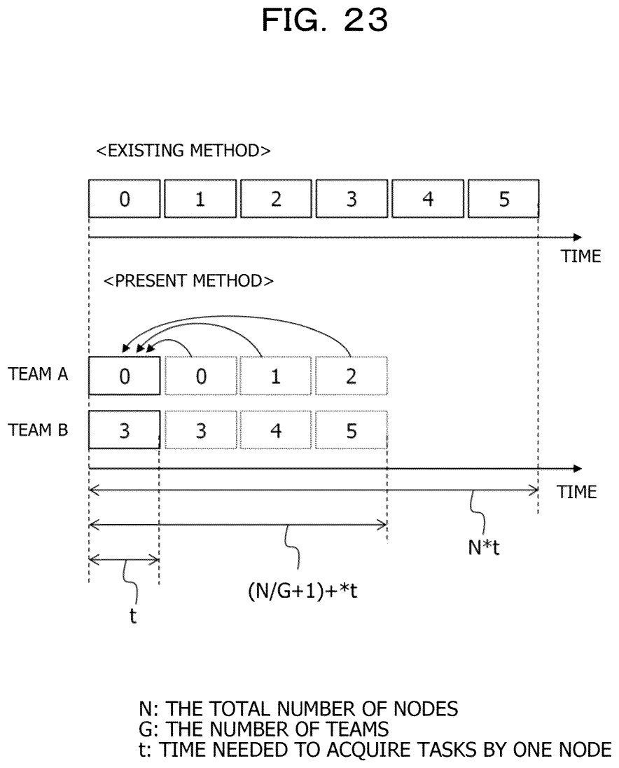

With reference to FIG. 23, an effect of the second embodiment will be specifically described. An existing method is similar to that of the example of FIG. 17. In the present method, each representative node of a team accesses an assigned range in the task list 32 of the shared file system 30 in parallel to generate the team task list 34 of each team. Then, other members access the team task list 34 generated by the representative node of the team (arrows in FIG. 23). Therefore, it is possible to reduce a standby time for accessing the task list in the entire system.

Furthermore, when it is assumed that the total number of nodes is N, the number of teams is G, and a time needed to acquire tasks by one node 20 is t, in the existing method, a time T until all nodes complete generation of the member task list 36 is T=N*t. On the other hand, in the present method, a time until the generation of the team task list 34 is completed, for example, a time T′ for the representative node to access the task list 32 is T′=t. Furthermore, the time T until all nodes complete the generation of the member task list 36 is T=(N/G+1)*t, which may be greatly shortened compared to the existing method.

Note that, in each of the embodiments described above, the case where the disclosed technology is applied to the virtual screening has been described. However, the embodiments are not limited to this. The disclosed technology may be applied to load distribution processing that needs access to a shared file. For example, it is effective in a case where a size of each task is different.

Furthermore, in each of the embodiments described above, the case where the number of members of each team is equal has been described. However, the number of members of each team may be different from each other.

Furthermore, in each of the embodiments described above, the first load distribution program and the second load distribution program are stored (installed) in the storage device in advance. However, the embodiments are not limited to this. The programs according to the disclosed technology may be provided in a form stored in a storage medium such as a compact disc read only memory (CD-ROM), a digital versatile disc read only memory (DVD-ROM), or a universal serial bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A management device comprising:
a memory; and
a processor coupled to the memory and configured to:
classify a plurality of arithmetic processing devices that executes a plurality of tasks in parallel by distributing loads into a plurality of arithmetic processing device groups;
select a representative arithmetic processing device from arithmetic processing devices that belong to each arithmetic processing device group;
notify the representative arithmetic processing device of identification information of other arithmetic processing devices that belong to an arithmetic processing device group to which the representative arithmetic processing device belongs;
instruct the representative arithmetic processing device to acquire information regarding tasks to be executed by the arithmetic processing devices that belong to the arithmetic processing device group from a first task list as a shared file in which information regarding the plurality of tasks is stored, and to generate a second task list;
notify each of the other arithmetic processing devices of identification information of the representative arithmetic processing device; and
instruct each of the other arithmetic processing devices to acquire information regarding tasks to be executed by the representative arithmetic processing device and each of the other arithmetic processing devices from the second task list generated by the representative arithmetic processing device, and to generate a third task list.

2. The management device according to claim 1, wherein the processor acquires identification information of the plurality of arithmetic processing devices reserved to execute the plurality of tasks, and classifies, based on the number of arithmetic processing devices that belong to each arithmetic processing device group specified in advance, the plurality of arithmetic processing devices into the plurality of arithmetic processing device groups.

3. The management device according to claim 2, wherein, in a case where the identification information is a number, the processor selects, among arithmetic processing devices that belong to each of the arithmetic processing device groups, an arithmetic processing device with the smallest or largest identification information as the representative arithmetic processing device.

4. The management device according to claim 1, wherein the processor:
divides tasks included in the first task list by the number of arithmetic processing device groups;
determines a range of tasks assigned to each of the plurality of arithmetic processing device groups in the first task list; and
instructs the representative arithmetic processing device to generate the second task list from the range in the first task list.

5. An arithmetic processing device that is any one of a plurality of arithmetic processing devices that executes a plurality of tasks in parallel by distributing loads, the arithmetic processing device comprising:
a memory; and
a processor coupled to the memory and configured to:
acquire, in a case where it is notified from a management device that the arithmetic processing device is a representative of an arithmetic processing device group and of identification information of other arithmetic processing devices that belong to the arithmetic processing device group, information regarding tasks to be executed by the arithmetic processing devices that belong to the arithmetic processing device group from a first task list as a shared file in which information regarding the plurality of tasks is stored, and to generate a second task list;
acquire information regarding tasks to be executed by the own device from the second task list, and to generate a third task list;
notify the other arithmetic processing devices that the second task list has been generated; and
execute tasks included in the third task list.

6. The arithmetic processing device according to claim 5, wherein the processor accesses the first task list after the processor locks the first task list, and unlocks the first task list when the generation of the second task list is completed.

7. The arithmetic processing device according to claim 5, wherein the processor generates the second task list by acquiring the information regarding the tasks one by one from the first task list and adding the acquired information regarding the tasks to the second task list, and ending the acquisition of the information regarding the tasks at a stage when a total size of the acquired information regarding the tasks exceeds a threshold according to the number of arithmetic processing devices included in the arithmetic processing device group.

8. The arithmetic processing device according to claim 5, wherein the processor acquires the information regarding the tasks to be executed by the own device from the second task list and generates the third task list in a case where the processor is notified from the management device of identification information of a representative arithmetic processing device of an arithmetic processing device group and notified from the representative arithmetic processing device that the second task list has been generated.

9. The arithmetic processing device according to claim 5, wherein, in a case where the processor is notified from the management device of a range of tasks assigned to an arithmetic processing device group to which the own device belongs in the first task list, the processor generates the second task list from the range in the first task list.

10. A load distribution method comprising:
classifying a plurality of arithmetic processing devices that executes a plurality of tasks in parallel by distributing loads into a plurality of arithmetic processing device groups;
selecting a representative arithmetic processing device from arithmetic processing devices that belong to each arithmetic processing device group;
notifying the representative arithmetic processing device of identification information of other arithmetic processing devices that belong to an arithmetic processing device group to which the representative arithmetic processing device belongs;
instructing the representative arithmetic processing device to acquire information regarding tasks to be executed by the arithmetic processing devices that belong to the arithmetic processing device group from a first task list as a shared file in which information regarding the plurality of tasks is stored, and to generate a second task list;
notifying each of the other arithmetic processing devices of identification information of the representative arithmetic processing device; and
instructing each of the other arithmetic processing devices to acquire information regarding tasks to be executed by the representative arithmetic processing device and each of the other arithmetic processing devices from the second task list generated by the representative arithmetic processing device, and to generate a third task list.

11. The load distribution method according to claim 10, further comprising:
acquiring identification information of the plurality of arithmetic processing devices reserved to execute the plurality of tasks; and
classifying, based on the number of arithmetic processing devices that belong to each arithmetic processing device group specified in advance, the plurality of arithmetic processing devices into the plurality of arithmetic processing device groups.

12. The load distribution method according to claim 11, further comprising:
in a case where the identification information is a number, selecting, among arithmetic processing devices that belong to each of the arithmetic processing device groups, an arithmetic processing device with the smallest or largest identification information as the representative arithmetic processing device.

13. The load distribution method according to claim 10, further comprising:
dividing tasks included in the first task list by the number of arithmetic processing device groups;
determining a range of tasks assigned to each of the plurality of arithmetic processing device groups in the first task list; and
instructing the representative arithmetic processing device to generate the second task list from the range in the first task list.
